(19) United States
(12) Patent Application Publication
(10) Pub. No.: US 2024/0174382 A1
(43) Pub. Date: May 30, 2024

(54) Space Debris Collecting and Evacuating Spacecraft

(71) Applicant: Joe Berlanga, Brandywine, MD (US)

(72) Inventor: Joe Berlanga, Brandywine, MD (US)

(21) Appl. No.: 18/341,802

(22) Filed: Jun. 27, 2023

Related U.S. Application Data
(60) Provisional application No. 63/428,392, filed on Nov. 28, 2022.

(51) Int. Cl. B64G 1/10; B64G 1/24; B64G 1/66

(52) U.S. Cl. CPC B64G 1/1078; B64G 1/242; B64G 1/66

(57) ABSTRACT

The present invention relates to a space debris collecting and evacuating spacecraft and an associated method of removing floating space debris. The spacecraft includes a space debris capturing mechanism and a debris container for collecting the captured space debris. An evacuation system re-orbits the stored space debris or sends same towards the sun to remove the floating space debris from near earth orbits. The spacecraft is propelled by integrated solar panel arrays and the space debris capturing can be activated/actuated automatically upon detecting the debris or can be done manually by a control center positioned on earth which is communicatively coupled to the spacecraft. The evacuation system has an associated pipe for evacuating the stored debris.

### CROSS-REFERENCE TO RELATED APPLICATION

The present application claims priority to, and the benefit of, U.S. Provisional Application No. 63/428,392, which was filed on Nov. 28, 2022 and is incorporated herein by reference in its entirety.

### FIELD OF THE INVENTION

The present invention relates generally to the field of spacecrafts. More specifically, the present invention relates to a novel and specialized spacecraft for collecting floating space debris/junk and evacuating same into other orbits or towards the sun for improving safety for additional spacecrafts launched into Earth's orbit. The spacecraft is similar to conventional spacecrafts, but has a debris container for storing space debris and an evacuation mechanism for deorbiting the stored debris. The spacecraft can capture and store both natural and manmade space debris. Accordingly, the present disclosure makes specific reference thereto. Nonetheless, it is to be appreciated that aspects of the present invention are also equally applicable to other like applications, devices and methods of manufacture.

### BACKGROUND

By way of background, space junk, or space debris, is any piece of machinery or debris left by humans in space. It can refer to big objects such as dead satellites that have failed or have been left in orbit at the end of their mission. It can also refer to smaller things, like bits of debris or paint flecks that have fallen off a rocket. More than 27,000 pieces of orbital debris, or space junk are tracked by the Department of Defense's global Space Surveillance Network (SSN) sensors. It is estimated that much more debris, which is too small to be tracked, but large enough to threaten human spaceflight and robotic missions exists in the near-Earth space environment.

Space debris small even as a tiny paint flack can damage spacecrafts. In fact, millimeter-sized orbital debris represents the highest mission-ending risk to most robotic spacecraft operating in low Earth orbit. Currently, to avoid encounters with space junk/space debris, spacecrafts perform debris avoidance maneuvers. In total, across all satellites, hundreds of collision avoidance maneuvers are performed every year, including by the International Space Station (ISS), where astronauts live. Also, NASA draws an imaginary box, known as the “pizza box” because of its flat, rectangular shape, around the space vehicle. This box is about 2.5 miles deep by 30 miles across by 30 miles long (4×50×50 kilometers), with the International Space Station in the center to avoid collision with space debris.

However, space debris is increasing daily with more satellites being orbiting around the earth. Currently, there is no technique, nor capable vehicle, to remove and collect space debris thereby decreasing safety of future spacecrafts.

Therefore, there exists a long-felt need in the art to effectively remove space junk. There is also a long-felt need in the art for a device that improves safety of spacecrafts orbiting in the space. Additionally, there is a long-felt need in the art for a system that eliminates collisions of spacecrafts with space debris floating in the space. Moreover, there is a long-felt need in the art for a unique spacecraft that collects debris from space and launches same into another orbit. Further, there is a long-felt need in the art for a novel spacecraft that reduces significant threats to commercial spacecrafts. Finally, there is a long-felt need in the art for a space debris collecting spacecraft that collects and deorbits the trash floating in the orbit.

The subject matter disclosed and claimed herein, in one embodiment thereof, comprises a specialized spacecraft designed to collect and evacuate space debris floating in/or near earth orbit. The spacecraft further comprising a spacecraft module, a cuboidal debris bin formed of aluminum alloy integrated inside the spacecraft module, the debris bin is configured to have a continuous opening along the length thereof for storing space debris, a debris evacuation system connected to the debris bin and configured for propelling the stored debris into another orbit or towards the sun. The space craft captures the debris by intercepting it within the bin.

In this manner, the space debris collecting and evacuating spacecraft of the present invention accomplishes all of the forgoing objectives and provides users with a specialized spacecraft designed to collect debris floating in near space (i.e., low orbit). The spacecraft also allows collected debris to be launched into another orbit or directly towards the sun for disposal. The spacecraft improves safety for additional spacecrafts launched into Earth's orbit by preventing direct collision and collision avoidance maneuvers.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a spacecraft designed to collect space debris floating in an orbit. The spacecraft further comprising a spacecraft module, a cuboidal debris bin formed of aluminum alloy positioned inside the spacecraft module, the debris bin is configured to have a continuous opening along the length thereof for storing space debris, a debris evacuation system for connection to the debris bin and configured for propelling the stored debris therefrom, a debris evacuation pipe for evacuating the propelled debris into another orbit or towards the sun. The spacecraft module is configured for capturing or extending a capturing device to capture a space debris item in order capture the debris and place same inside the debris bin, wherein use of the suction or the capturing device is performed automatically by the spacecraft upon detecting a space debris.

In yet another embodiment, the spacecraft captures the space debris on manual activation from a control center positioned on earth and connected to the spacecraft.

In yet another embodiment, the spacecraft is configured to store all types of artificial and natural space debris.

The subject matter disclosed and claimed herein, in one embodiment thereof, comprises a spacecraft for removing space debris from near Earth orbit. The spacecraft further comprising a debris container made of light aluminum alloy for storing space debris, a space debris capturing means, a space debris evacuation system for deorbiting the stored space debris, the space debris capturing means and the space debris evacuation system are provided electric power by a pair of solar panels array disposed on the spacecraft.

In yet another embodiment, the spacecraft interacts with space debris to directly store the space debris inside the debris container and evacuate same towards the sun or another orbit.

In yet another embodiment, a method for collecting debris floating in space is described. The method comprising the steps of providing a specialized spacecraft designed to collect debris floating in space, the spacecraft is in the shape of a basket functioning like a garbage can and has an evacuation system for either deorbiting the space debris or sending same towards the sun. The method also includes locating space debris, capturing the space debris, storing the space debris inside the garbage can, and propelling the stored space debris for deorbiting the space debris.

In yet another embodiment, the spacecraft of the present invention is easily and efficiently manufactured, marketed, and available to space agencies and governments in cost-effective manner and is easily used for collecting and evacuating floating space debris.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a space debris collecting spacecraft of the present invention in accordance with the disclosed architecture;

FIG. 2 illustrates a perspective view of a debris container along with the garbage evacuation conduit used in the space junk collecting and evacuating spacecraft of the present invention in accordance with the disclosed architecture;

FIG. 3 illustrates a schematic view of communication of the specialized spacecraft with the control center on the earth in accordance with the disclosed architecture;

FIG. 4 illustrates a flow diagram depicting a process of collecting and evacuating space debris by the space debris collecting spacecraft of the present invention in accordance with the disclosed architecture;

FIG. 5 illustrates a perspective view of the spacecraft capturing a space debris item to accommodate inside the debris bin in accordance with the disclosed architecture; and

FIG. 6 illustrates a flow diagram depicting another process of collecting and evacuating space debris by the space debris collecting spacecraft of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art to effectively remove space junk and/or space debris. There is also a long-felt need in the art for a device that improves safety of spacecrafts orbiting in the space. Additionally, there is a long-felt need in the art for a system that eliminates collisions of spacecrafts with space debris floating in space. Moreover, there is a long-felt need in the art for a unique spacecraft that collects debris from space and launches same into another orbit. Further, there is a long-felt need in the art for a novel spacecraft that reduces significant threats to commercial spacecrafts. Finally, there is a long-felt need in the art for a space debris collecting spacecraft that collects and deorbits the trash floating in an orbit.

The present invention, in one exemplary embodiment, is a method for collecting debris floating in space. The method comprising the steps of providing a specialized spacecraft designed to collect debris floating in space, the spacecraft is in the shape of a basket or container functioning like a garbage can and has an evacuation system for either deorbiting the space debris or sending same towards the sun. The method also includes locating space debris, capturing the space debris, storing the space debris inside the container, and propelling the stored space debris for deorbiting the space debris.

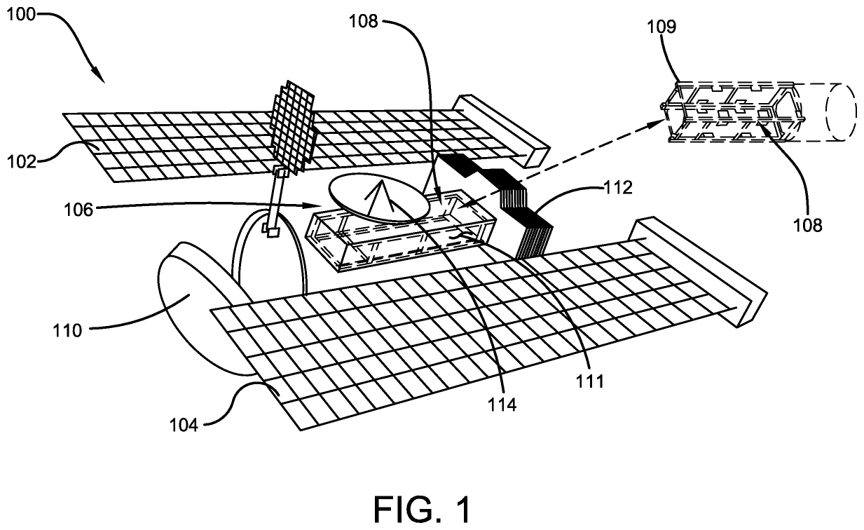

Referring initially to the drawings, FIG. 1 illustrates a perspective view of one potential embodiment of space debris collecting spacecraft of the present invention in accordance with the disclosed architecture. The space debris collecting spacecraft 100 of the present invention is designed to collect space debris floating in the orbit of the Earth. More specifically, the spacecraft 100 has a pair of solar arrays 102, 104 for providing power to run the sensors, active heating, cooling, and telemetry unit. The solar arrays 102, 104 also provide power for solar-electric propulsion (not shown). The spacecraft module 106 is designed specially to accommodate and capture the debris orbiting in space and has integrated thermal blankets or insulation 111 covering or lining the walls of the module 106. The module 106 has a debris container 108 constructed of a lightweight aluminum alloy frame 109 for accommodating and capturing the debris. The spacecraft 100 is configured to eject the accommodated debris to other orbits or towards the sun as discussed in detail later in the disclosure. Alternatively, the spacecraft 100 can be deorbited or directed towards the sun. The spacecraft can jettison the debris container 108 when full or when desired.

A sunshade or sunshield door 110 is a parasol positioned on the spacecraft 100 that diverts, shields, or otherwise reduces some of the sun's radiation, preventing same from hitting the spacecraft 100 and thereby reducing its insolation, which results in reduced heating and reduced negative thermal effects. A telemetry component or unit 112 is configured to provide telemetry data, including digital data representing engineering measurements, such as the temperatures of parts of the spacecraft, and science data, such as images from cameras and more to controlling stations positioned on earth. The spacecraft 100 is also configured to receive commands from the controlling stations for effectively collecting space debris. The telemetry component or unit 112 has an integrated high-resolution camera (HRC) that helps in identification of detected space debris such that the debris can be captured and accommodated inside the debris container 108.

One or more spacecraft antennas 114 are mounted on the body of the spacecraft 100 for providing coverage for specific regions above the earth. The antennas 114 also help the spacecraft 100 send information and pictures back to Earth using the Deep Space Network (DSN). It should be noted that other essential components such as a control system of a generic spacecraft are positioned inside the spacecraft 100 and are not shown here for brevity purposes. The debris container 108 can withstand extremely high pressure and weight and can accommodate different types of natural and man-made space debris. The debris container 108 is integrated inside the spacecraft module 106 and has an evacuation mechanism for ejecting the garbage or debris into other orbits. As a result, the spacecraft 100 reduces other conventional spacecrafts' needs to activate collision avoidance maneuvers in order to prevent collisions.

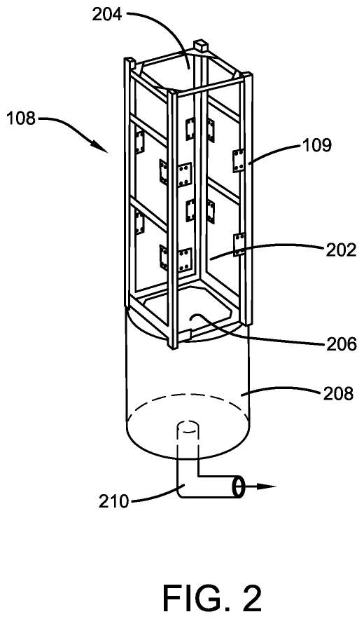

FIG. 2 illustrates a perspective view of the debris container 108 along with the garbage evacuation conduit used in the space junk collecting and evacuating spacecraft of the present invention in accordance with the disclosed architecture. The debris container 108 is preferably cuboidal in shape and is made of lightweight aluminum that can withstand high temperature and pressure. The debris container 108 forms a cavity 202 for collection of space debris such that cavity 202 extends from the first end 204 to the opposite end 206 of the debris container 108.

A debris evacuation system 208 having an integrated pipe 210 is attached to the debris container 108 and is used for evacuating the garbage accommodated in the debris container 108 into other orbits and/or towards the sun. The system 208 generates an orbital speed (i.e., propulsion) enough to send the debris into other orbits, thereby helping to remove floating debris in the lower orbits of the earth. The integrated pipe 210 can adjust the diameter thereof for allowing debris of different sizes to pass therethrough into the outer or other orbit. The debris container 108 conforms to the shape and size of the spacecraft module 106 as illustrated in FIG. 1. Further, the evacuation system 208 can be automatically activated/actuated or can be manually activated/actuated by a control station positioned on earth.

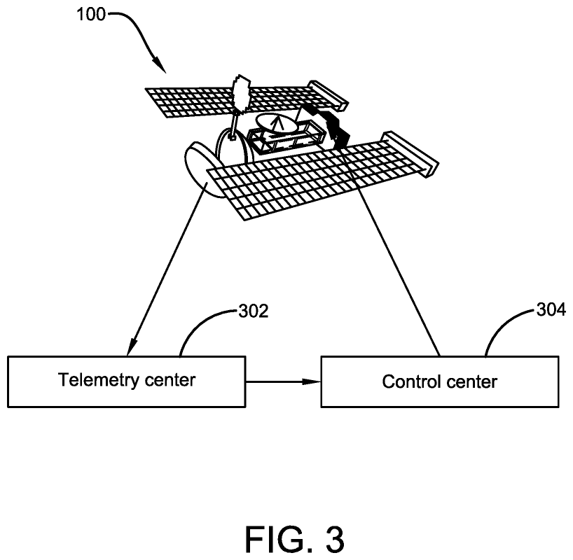

FIG. 3 illustrates a schematic view of communication of the specialized spacecraft with the control center stationed on earth in accordance with the disclosed architecture. The spacecraft 100 is configured to provide telemetry data to a ground telemetry center 302, wherein the telemetry data is collected by the local telemetry processor of the spacecraft 100. The telemetry data provides insights about attitude and orbit information, wherein the information is provided to the ground control center 304 in real-time. The control center 304 is configured to track the trajectory and motion of the spacecraft 100 along with the storage of debris inside the debris container 108. The evacuation system 208 is activated/actuated when there is a threshold level of debris stored in the debris container 108. Preferably, the evacuation system 208 is automatically activated/actuated when, for example, a majority of the total space or volume (i.e., greater than 60%) of the debris container 108 is filled with space debris. Alternatively, the evacuation system 208 can be activated/actuated continuously to evacuate the stored debris in real time.

It is important to understand that the spacecraft 100 is designed to collect space debris. In situations where the size of the debris is bigger than the capacity of the spacecraft 100, then, the spacecraft 100 can avoid capturing that particular space debris. In the preferred embodiment, the spacecraft 100 is capable of capturing and storing any type of artificial and natural space debris of all types and sizes.

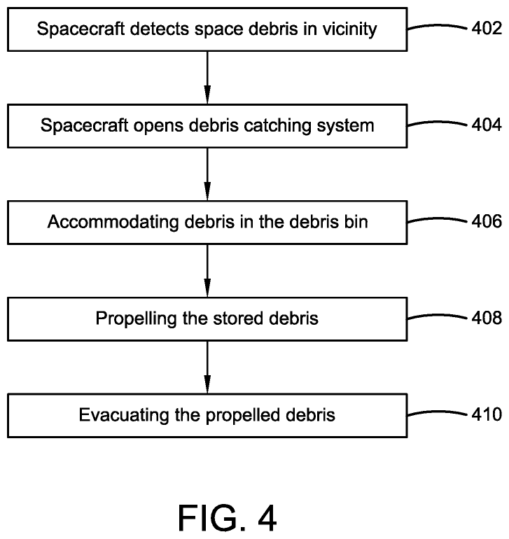

FIG. 4 illustrates a flow diagram depicting a process of collecting and evacuating space debris by the space debris collecting spacecraft of the present invention in accordance with the disclosed architecture. Initially, the spacecraft 100 is launched in an orbit and detects space debris in the vicinity of the spacecraft (Step 402). The spacecraft 100 can use different means such as an open first end of the container debris bin and one or more of cameras to detect space debris. The spacecraft 100 can also be pre-programmed to detect certain types of space debris. Then, the spacecraft 100 positions itself and then opens up or activates debris capturing/catching system (Step 404). The spacecraft 100 can use different means including but not limited to suction or using a capturing means such as a sturdy capturing device for collecting the space debris. Once, the debris is captured, then, the debris is stored or accommodated in the debris bin of the spacecraft module (Step 406).

For evacuating the debris, the stored debris of the debris bin is propelled using the debris evacuation system to a speed allowing the debris to be evacuated into other orbits and/or towards the sun (Step 408). Finally, the stored debris is evacuated through the evacuation pipe into the other orbits, thereby emptying the debris container (Step 410). Alternatively, the spacecraft 100 or the jettisoned debris bin 108 is deorbited or directed towards the sun.

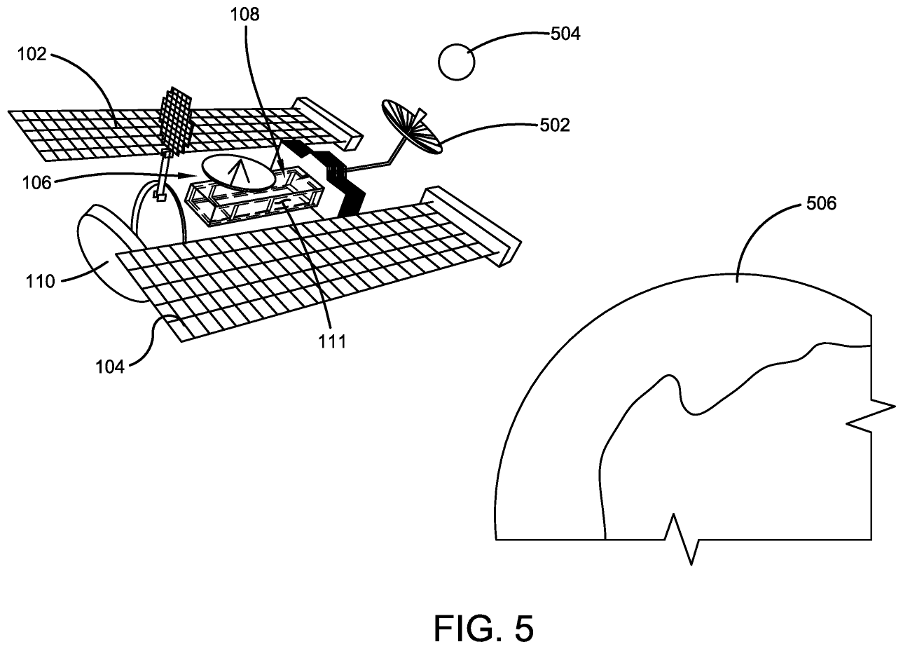

FIG. 5 illustrates a perspective view of the spacecraft capturing space debris to be deposited and accommodated inside the debris bin in accordance with the disclosed architecture. The spacecraft 100 can use different techniques, such as, creating a suction or extending a capturing device 502 for capturing and collecting the space debris 504. The capturing device 502 is automatically launched or can also be manually launched from the control center as illustrated in FIG. 3 for targeting and capturing the debris 504 inside the debris container 108.

The spacecraft 100 is designed to orbit around the earth 506 similar to conventional spacecrafts and is equipped with all the major subsystems of a spacecraft necessary to keep the craft in orbit. The capturing device 504 is configured to capture (i.e., swallow) the space debris 504 to accommodate inside the debris container 108. Preferably, the space debris 504 is accommodated through the first end 204 of the debris container 108 as illustrated in FIG. 2.

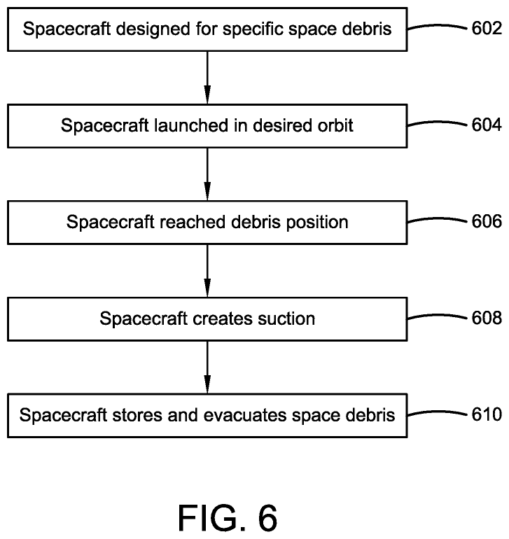

FIG. 6 illustrates a flow diagram depicting another process of collecting and evacuating space debris by the space debris collecting spacecraft of the present invention in accordance with the disclosed architecture. In the present embodiment, the spacecraft 100 is designed for collecting and evacuating a specific space debris (Step 602). It is useful for the cases where a specific type of space debris is prone to collide with satellites revolving in a specific orbit. Then, the spacecraft is launched into a desired orbit around the earth, sun, moon, or any other planet (Step 604). Based on the pre-programmed location and destination, the spacecraft reaches the debris position (Step 606).

Then, in the present embodiment, the spacecraft aligns to the debris and creates a suction to ‘swallow’ the debris inside the debris bin or container of the spacecraft (Step 608). Finally, the spacecraft stores the debris and evacuates same as discussed in FIG. 4 (Step 610). Alternatively, the spacecraft 100 or the jettisoned debris bin 108 is deorbited or directed towards the sun.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “space junk collecting and evacuating spacecraft”, “space debris collecting spacecraft”, “spacecraft”, and “specialized spacecraft” are interchangeable and refer to the space debris collecting and evacuating spacecraft 100 of the present invention.

Notwithstanding the forgoing, the space debris collecting and evacuating spacecraft 100 of the present invention can be of any suitable size and configuration as is known in the art without affecting the overall concept of the invention, provided that it accomplishes the above-stated objectives. One of ordinary skill in the art will appreciate that the space debris collecting and evacuating spacecraft 100 as shown in the FIGS. are for illustrative purposes only, and that many other sizes and shapes of the space debris collecting and evacuating spacecraft 100 are well within the scope of the present disclosure. Although the dimensions of the space debris collecting and evacuating spacecraft 100 are important design parameters for user convenience, the space debris collecting and evacuating spacecraft 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A space debris collecting spacecraft comprising:
a spacecraft having a plurality of solar arrays, a spacecraft module, a debris container, and a sunshield;
wherein said plurality of solar arrays collect solar energy to power a sensor, a heater, a cooler, and a telemetry unit;
wherein said spacecraft module having integrated thermal insulation lining the walls of said spacecraft module;
wherein said debris container having a frame defining a cavity within said frame;
a debris evacuation system integrated with said debris container for evacuating debris captured in said debris container; and
further wherein said sunshield having a shield door for shielding a portion of said spacecraft for reducing some of the sun's radiation on said spacecraft.

2. The space debris collecting spacecraft of claim 1, wherein said shield door is a parasol.

3. The space debris collecting spacecraft of claim 2, wherein said frame is an aluminum alloy.

4. The space debris collecting spacecraft of claim 1, wherein said debris evacuation system having an evacuation pipe for directing said evacuating debris from said debris container.

5. The space debris collecting spacecraft of claim 4, wherein the directing said evacuating debris is from a first orbit to a second orbit.

6. The space debris collecting spacecraft of claim 4, wherein the directing said evacuating debris is from a first orbit to a direction towards the sun.

7. The space debris collecting spacecraft of claim 1, wherein said telemetry unit providing telemetry data to a controlling station positioned on earth.

8. The space debris collecting spacecraft of claim 7, wherein said telemetry data includes data selected from a group consisting of a temperature and an image from a camera.

9. The space debris collecting spacecraft of claim 8, wherein said camera is an integrated high-resolution camera.

10. The space debris collecting spacecraft of claim 9, wherein said telemetry unit receiving commands from said controlling station positioned on earth.

11. The space debris collecting spacecraft of claim 10, wherein said spacecraft module having a spacecraft antenna for said providing telemetry data and said receiving commands.

12. The space debris collecting spacecraft of claim 11, wherein said spacecraft antenna connected to a deep space network.

13. A space debris collecting spacecraft comprising:
a spacecraft having a plurality of solar arrays, a spacecraft module, a debris container, and a sunshield;
wherein said plurality of solar arrays collect solar energy to power a sensor, a heater, a cooler, and a telemetry unit;
wherein said spacecraft module having integrated thermal insulation lining the walls of said spacecraft module;
wherein said debris container having a frame defining a cavity within said frame;
a debris evacuation system integrated with said debris container for evacuating debris captured in said debris container;
wherein said sunshield having a shield door for shielding a portion of said spacecraft for reducing some of the sun's radiation on said spacecraft;
wherein said debris evacuation system having a jettison control for jettisoning said debris container from said spacecraft;
wherein the jettisoning said debris container is from a first orbit to a second orbit; and
further wherein the jettisoning said debris container having a propulsion including an orbital speed.

14. The space debris collecting spacecraft of claim 13, wherein said debris evacuation system is automatically actuated.

15. The space debris collecting spacecraft of claim 13, wherein said telemetry unit providing telemetry data to a controlling station positioned on earth.

16. The space debris collecting spacecraft of claim 15, wherein said telemetry unit receiving commands from said controlling station positioned on earth.

17. The space debris collecting spacecraft of claim 16, wherein said spacecraft module having a spacecraft antenna for said providing telemetry data and said receiving commands.

18. The space debris collecting spacecraft of claim 17, wherein said debris evacuation system is actuated by receiving a command from said control station positioned on earth.

19. A space debris collecting spacecraft comprising:
a spacecraft having a plurality of solar arrays, a spacecraft module, a debris container, and a sunshield;
wherein said plurality of solar arrays collect solar energy to power a sensor, a heater, a cooler, and a telemetry unit;
wherein said spacecraft module having integrated thermal insulation lining the walls of said spacecraft module;
wherein said debris container having a frame defining a cavity within said frame;
a debris evacuation system integrated with said debris container for evacuating debris captured in said debris container;
wherein said sunshield having a shield door for shielding a portion of said spacecraft for reducing some of the sun's radiation on said spacecraft;
wherein said debris evacuation system having an evacuation pipe for directing said evacuating debris from said debris container;
wherein the directing said evacuating debris is from a first orbit to a second orbit; and
wherein said directing said evacuating debris including a propulsion having an orbital speed;
wherein said telemetry unit providing telemetry data to a ground telemetry center; and
further wherein said telemetry data is real-time information including an altitude and an orbit.

20. The space debris collecting spacecraft of claim 19, wherein said telemetry data further including a level of debris stored in said debris container.
